(19) United States
(12) Patent Application Publication
(10) Pub. No.: US 2007/0246405 A1
(43) Pub. Date: Oct. 25, 2007

(54) Flushing agent conditioning device for a hard material-tipped cutting machine

(76) Inventor: Ralf Pfeiffer, Sontheim (DE)

Correspondence Address: ABELMAN, FRAYNE & SCHWAB, 666 THIRD AVENUE, 10TH FLOOR, NEW YORK, NY, 10017, US

(21) Appl. No.: 11/789,638

(22) Filed: Apr. 24, 2007

(30) Foreign Application Priority Data
Apr. 25, 2006 (DE) 10 2006 000 198.2

(51) Int. Cl. B01D 35/00

(52) U.S. Cl. 210/90; 210/97; 451/446

(57) ABSTRACT

A flushing agent conditioning device (1) for a hard material-tipped cutting machine (2) includes a flushing agent circulation circuit that can be closed at least partially with respect to a hard material-tipped tool (4) which is to be flushed and that has a discharge trough (8) and flushing agent pump (9) arranged one behind the other in the direction of flow behind the tool (4), wherein a sensor (15, 15′) is provided which can be evaluated electronically by computing means (14, 14′) with a transformation algorithm and which is sensitive to the flushing agent pressure (p) prevailing behind the flushing agent pump (9) in the direction of flow.

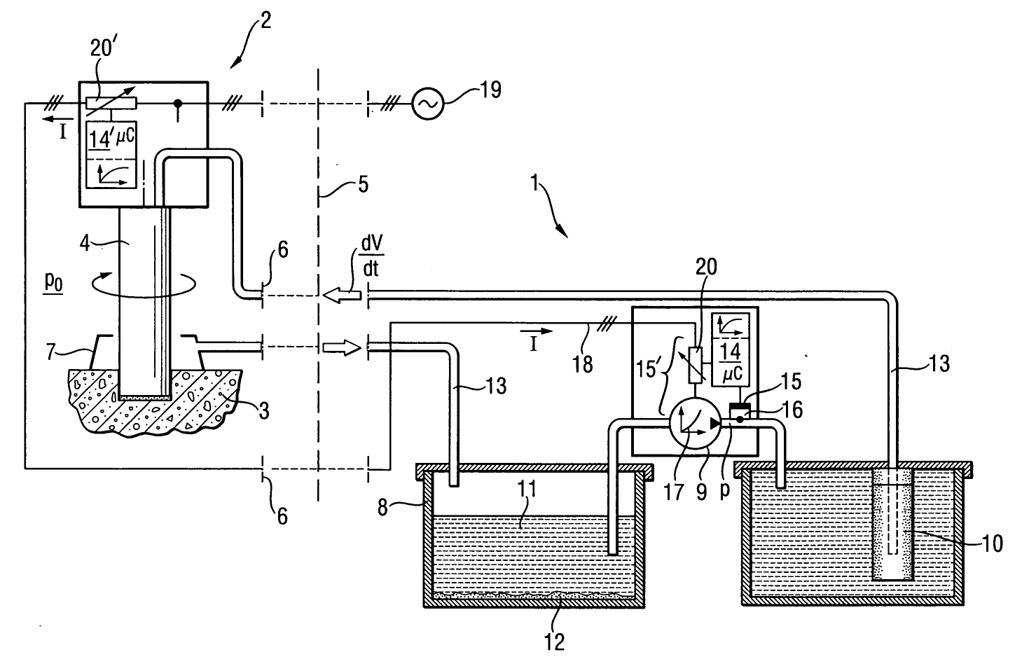

### BACKGROUND OF THE INVENTION

1. Field of the Invention

The invention relates to a flushing agent conditioning device for filtering out solids from a flushing agent that is used in hard material-tipped cutting machines such as diamond coring machines, diamond-blade circular saws or diamond wire saws as a necessary accessory for abrasive removal of rock, concrete, masonry and the like materials.

2. Description of the Prior Art

In the abrasive removal of rock, concrete, masonry and the like materials, flushing agents are used to carry solids removed by a hard material-tipped tool away from the machining site. The solids occurring as particles are drained from the machining site along with the flushing agent, preferably water. In order to recycle the flushing agent within a closed flushing agent circulation circuit or to discharge the solids into a drainage system so as to be free of harmful materials, the solids contained in the flushing agent must be separated out. These solids have high concentrations of rock powder and detached hard material dust particles (diamond splinters, polycrystalline cubic boron nitrides (PCBN), corundum) of the hard material-tipped cutting machines and, therefore, have an extensively abrasive effect by themselves. In addition, the flushing agent causes appreciable calcification of the flushing agent circulation circuit because of the high pH generated by the basic rock powder.

German Publication DE 19810912 discloses an autonomous flushing agent conditioning device of the kind mentioned above which is designed for core drilling systems and which has an unregulated flushing agent circulation circuit located behind the hard material-tipped tool and that can be closed with respect to a to-be-flushed hard material-tipped tool and that includes a discharge trough, flushing agent pump, and filter unit arranged one behind the other in the direction of flow.

According to International Publication WO 0513175, a mechanical flowmeter which is integrated in the flushing agent circulation circuit of a portable circular rock saw is optically readable so as to assist the person using it in monitoring and regulating the flushing agent circulation circuit. However, mechanical flowmeters have a high risk of failure as a result of flushing agents of this kind which are highly abrasive and lead to calcification.

In modern, high-power hard material-tipped cutting machines, however, the selection of the optimal but within narrow limits, supply of the flushing agent to the tool is a very important process parameter serving as a monitoring and regulating parameter for the computer of the hard material-tipped cutting machine. The actual quantity of flushing agent flowing through the flushing agent circulation circuit is an essential physical quantity.

According to Japanese publication JP 10180750, the flushing agent conditioning device in diamond wire saws is controlled by a computer which controls the quantity of flushing agent flowing through a secondary circulation circuit of a heat exchanger which is used for cooling, for regulating the temperature by means of an electronically controllable valve. No measurement or regulation of the throughflow quantity in the flushing agent circulation circuit is carried out.

Further, the theoretical principle of measuring throughflow based on the drop in pressure over the flow resistance in a pipe according to the Hagen-Poiseuille law is known. As generally applied according to European publication EP 0565485, the amount of flow through a controllable diaphragm slide arranged in a pipeline is determined in a purely computational manner by pressure measurements taken on both sides by pressure measuring probes, using flow resistance values that have been calibrated beforehand and stored. This general solution is relatively uneconomical.

It is an object of the present invention to realize a robust electronic throughflow quantity sensor for the highly abrasive flushing agent of the flushing agent conditioning device for a hard material-tipped cutting machine for implementing a computer-assisted monitoring and/or regulating circuit.

### SUMMARY OF THE INVENTION

This and other objects of the present invention, which will become apparent hereinafter, are achieved b y providing a flushing agent conditioning device for a hard material-tipped cutting machine including a flushing agent circulation circuit located behind a to-be-flushed tool and that can be closed at least partially with respect to the to-be-flushed hard material-tipped tool and that has a discharge trough and flushing agent pump arranged one behind the other in the direction of the flow, a sensor that can be evaluated electronically by computing means with a transformation algorithm and that is sensitive to the flushing agent pressure prevailing behind the flushing agent pump in the direction of flow.

The electronically evaluated sensor, which is sensitive to the flushing agent pressure prevailing behind the flushing agent pump in the direction of flow, requires that the throughflow quantity is calculated directly by computing means with a transformation algorithm (e.g., with measured values that are stored in tabular or functional form and which are correlated with flow resistance values) characterizing the portion of the circulation circuit extending from behind the flushing agent pump, i.e., on its pressure side, to the tool. In particular, this makes use of the fact that in hard material-tipped cutting machines, at the tool, the ambient pressure (usually atmospheric pressure) which is known to necessarily act on the flushing agent, which is then released, and therefore, in this specific case, the pressure differential which is required in theory for the calculation, can be definitely determined from a single pressure measurement. Since the electronic throughflow quantity sensor has no mechanically moving parts, it is sufficiently robust for use in the construction industry. Accordingly, it is possible to dispense with a second sensor for measuring the flushing agent pressure at the other end of the portion of the circulation circuit that forms the flow resistance. This substantially simplifies construction. Therefore, the computing means can execute conventional monitoring algorithms, i.e., execution of an error routine (e.g., warning signal or shutdown) when a predetermined minimum throughflow value is not met, and conventional regulating algorithms, i.e., a PID regulation to a predetermined reference throughflow quantity.

A filter unit located in the flushing agent circulation circuit is advantageously arranged behind the sensor in the direction of flow so that the change in its filter characteristics, e.g., in the event that it becomes clogged, is reflected in the change in the flow resistance value in the measured circulation circuit portion and can accordingly be indirectly monitored by the computing means.

The sensor is advantageously constructed as a discretely switching pressure-dependent threshold switch (e.g., a liquid-tight press switch) and is connected to the flushing agent on the pressure side of the flushing agent pump so as to transmit pressure, which is sufficient for a simple monitoring and regulating system based on a discrete throughflow quantity threshold, so that this monitoring and regulating system can advantageously be realized in a robust and economical manner.

As an advantageous alternative, the sensor is constructed as an electronic pressure sensor and, also advantageously, has an air cushion preceding it and has a continuous measurement range so that a continuous range of throughflow quantity values can be detected by a continuous transformation operation which is carried out by the computing means. The constant transformation operation is carried out by the computing means by means of conventional interpolation routines between a plurality of stored discrete transformation reference points.

As a further advantage, the electronically evaluated sensor, or another electronically evaluated sensor, is designed to measure pressure indirectly using a continuously monotonic current-pressure characteristic of the flushing agent pump by combining this flushing agent pump with an electronically evaluated current sensor arranged in the power supply circuit. It is further advantageous that the current sensor is a low-impedance resistor which can be evaluated by computing means so that a sensor which measures pressure directly need not be arranged in the highly abrasive flushing agent. It is also advantageous that the computing means can directly control, e.g., switch off, the flushing agent pump in the flushing agent conditioning device by arranging a controllable resistor, e.g., a power MOS-FET, in the power supply circuit. These computing means can be the computing means of the flushing agent conditioning device as well as the computing means of the hard material-tipped cutting machine and can regulate both of the latter simultaneously, e.g., in conventional master-slave mode.

In an autonomous flushing agent conditioning device that includes independent computing means, the current sensor is advantageously arranged in the flushing agent conditioning device itself and is connected to the computing means so as to realize an autonomous flushing agent conditioning device which is capable of monitoring and regulating.

In a combined flushing agent conditioning/hard material-tipped cutting machine system with computing means integrated in the hard material-tipped cutting machine, the current sensor, or another current sensor, can even be arranged in the hard material-tipped cutting machine in an advantageous manner insofar as the flushing agent pump in the flushing agent conditioning device is fed by a power supply branch with this current sensor, so that a flushing agent conditioning/hard material-tipped cutting machine system is achieved which is capable of monitoring and regulating. In this case, the electronically evaluated sensor is first formed by integrating the flushing agent conditioning device in the flushing agent conditioning/ hard material-tipped cutting machine system.

The novel features of the present invention which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The SINGLE FIGURE of the drawings shows a schematic view of the flushing agent conditioning device according to the present invention.

### DETAILED DESCRIPTION OF THE PREFERRED EMBODIMENT

As is shown in the drawing, a flushing agent conditioning/hard material-tipped cutting machine system includes an autonomous flushing agent conditioning device 1, and an autonomous hard material-tipped cutting machine 2 in the form of a core drilling machine for drilling holes in rock 3 with a liquid-flushed hard material-tipped tool 4 in the form of a rotating diamond core drill bit which are assembled corresponding to the system's purpose and which are suitably connected to one another at a connection interface 5 by line couplers 6 (for electric currents and for liquids). A flushing agent circulation circuit with a throughflow quantity dV/dt is closed by the hard material-tipped cutting machine 2 and has a collecting ring 7 which is open to atmospheric pressure Po, a discharge trough 8, a flushing agent pump 9, and a filter unit 10 which are arranged one after the other in the direction of flow behind the tool 4. The flushing agent 11 in the form of water with solids 12 flows between the collecting ring 7 and the tool 4 in closed, pressure-tight pipelines 13.

In both the flushing agent conditioning device 1 and the hard material-tipped cutting machine 2, computing means 14, 14′ in the form of a microcontroller μC with a stored transformation rule (measured value−>throughflow quantity dV/dt) specific to the flushing agent conditioning and with a transformation algorithm are connected to an electronically evaluated sensor 15, 15′ in the flushing agent conditioning device 1 and in the hard material-tipped cutting machine 2, respectively. The sensor 15, 15′ senses the prevailing flushing agent pressure p behind the flushing agent pump 9 on the pressure side in the flow direction. The computing means 14, 14′ contain conventional monitoring algorithms with an error routine with respect to a limiting throughflow value and conventional regulating algorithms of a PID regulation to a predetermined reference throughflow quantity.

The sensor 15, which can be evaluated electronically by the computing means 14 arranged in the flushing agent conditioning device 1, is designed, to measure pressure directly, as a discretely switching pressure-dependent threshold switch in the form of a liquid-tight press switch or as an electronic pressure sensor and is connected, via a preceding air cushion 16, to the flushing agent 11 on the pressure side of the flushing agent pump 9 so as to transmit pressure. The associated transformation rule (pressure p−>throughflow quantity dV/dt) specific to the flushing agent conditioning is stored in the computing means 14 of the flushing agent conditioning device 1.

Also, by using the continuously monotonic current-pressure characteristic 17 of the flushing agent pump 9, an electronically evaluated sensor 15′ which measures pressure indirectly is formed by a current sensor 20 in the form of a controllable resistance which is arranged in the power supply circuit 18 of the flushing agent pump 9 and which can be evaluated electronically by the computing means 14 of the flushing agent conditioning device 1. This current-pressure characteristic 17 is taken into account in the associated transformation rule (current I−>throughflow quantity dV/dt) of the computing means 14 specific to the flushing agent conditioning.

In the flushing agent conditioning/hard material-tipped cutting machine system, the flushing agent conditioning device 1 is connected to the power supply system 19 via the hard material-tipped cutting machine 2. Accordingly, the current sensor 20′ in the form of a controllable resistor which can be electronically evaluated by the computing means 14′ of the hard material-tipped cutting machine 2 forms a sensor 15′ which can be electronically evaluated by the computing means 14′ so as to measure pressure indirectly, also with the continuously monotonic current-pressure characteristic 17 of the flushing agent pump 9. The associated transformation rule (current I−>throughflow quantity dV/dt) specific to the flushing agent conditioning is stored in the computing means 14′ of the hard material-tipped cutting machine 2.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A flushing agent conditioning device for a hard material-tipped cutting machine (2), comprising a flushing agent circulation circuit that can be closed at least partially with respect to a to-be-flushed hard material-tipped tool (4) and that includes a discharge trough (8), and flushing agent pump (9) arranged one behind the other in a direction of flow; and a sensor (15, 15′) which can be evaluated electronically by computing means (14, 14′) with a transformation algorithm and which is sensitive to the flushing agent pressure (p) prevailing behind the flushing agent pump (9) in the direction of flow.

2. A flushing agent conditioning device according to claim 1, further comprising a filter unit (10) located in the flushing agent circulation circuit behind the electronically evaluated sensor (15, 15′) in the direction of flow.

3. A flushing agent conditioning device according to claim 1, wherein the electronically evaluated sensor (15) is formed as a discretely switching, pressure-dependent threshold switch connected with a flushing agent (11) on a pressure side of the flushing agent pump (9) so as to sense pressure.

4. A flushing agent conditioning device according to claim 1, wherein the electronically evaluated sensor (15) is formed as an electronic pressure sensor with a continuous measurement range connected with a flushing agent (11) on a pressure side of the flushing agent pump (9) so as to sense pressure.

5. A flushing agent conditioning device according to claim 1, wherein the electronically evaluated sensor (15′) is formed as a sensor for measuring pressure indirectly, and the flushing agent pump (9) with a continuously monotonic current-pressure characteristic (17) is combined with an electronically evaluated current sensor (20, 20′) arranged in a power supply circuit (18) of the flushing agent pump (9).

6. A flushing agent conditioning device according to claim 5, wherein the electronically evaluated sensor (20) is connected to the integrated computing means (14).

7. A flushing agent conditioning device according to claim 5, wherein the electronically evaluated sensor (20′) is arrangeable in the hard material-tipped cutting machine (2).
